(19) United States
(12) Patent Application Publication
(10) Pub. No.: US 2026/0160603 A1
(43) Pub. Date: Jun. 11, 2026

(54) SENSOR COVER AND RELATED METHODS

(71) Applicant: ADDIUM, INC., Pullman, WA (US)

(72) Inventors: Benjamin J. WALDEN, Moscow, ID (US); Takuya OHKI, Pullman, WA (US); Gregory M. KELLEY, Pullman, WA (US); Rob BURTON, Pullman, WA (US)

(21) Appl. No.: 18/975,912

(22) Filed: Dec. 10, 2024

(51) Int. Cl. G01K 1/10; G01N 27/04; G01N 27/07; G01N 27/22

(52) U.S. Cl. CPC G01K 1/10; G01N 27/048; G01N 27/07; G01N 27/225; G01N 27/226

(57) ABSTRACT

A system for protecting a thermopile temperature sensor can include a water activity meter including the thermopile temperature sensor, a substrate of the water activity meter having a cavity, with the thermopile temperature sensor disposed in the cavity, and a sensor cover shielding the thermopile temperature sensor. The sensor cover is attached to the substrate to seal the cavity while permitting electromagnetic radiation through the sensor cover to the thermopile temperature sensor.

### TECHNICAL FIELD

The present disclosure relates generally to protecting sensors in scientific instruments from degradation, corrosion, and failure.

### BACKGROUND

Parameters of a material can be measured with sensors. In some uses, sensors can be sensitive to the sample environment, which can cause contamination and corrosion of the sensor, resulting in degradation of, and potential failure of, the sensor. For example, in a water activity meter, when a temperature parameter cannot be measured directly due to adverse conditions, a thermocouple can be used. For more precise measurements, a thermopile can be used. A thermopile is a device that generates a voltage when exposed to a temperature gradient, or a change in temperature across two points. It is composed of several thermocouples connected in a series to track temperature changes on a wider scale.

Thermopile sensors may be problematic when they are housed in materials that are susceptible to corrosion. Taking samples of corrosive materials or samples in harsh environments can hinder the accuracy and effectiveness of the thermopile, making it more difficult to take an accurate sample.

### SUMMARY

Embodiments disclosed herein include systems, assemblies, and methods for protecting sensors. One aspect of the present disclosure relates to a system for protecting a thermopile temperature sensor, wherein the system comprises a water activity meter comprising a thermopile temperature sensor and a substrate and defining a sample chamber, wherein the substrate of the water activity meter defines a cavity containing the thermopile temperature sensor, and a sensor cover attached to the substrate and sealing the cavity, wherein the sensor cover is configured to permit electromagnetic radiation to pass through the sensor cover to the thermopile temperature sensor from the sample chamber.

In some examples, the sensor cover comprises a thickness between about 0.3 millimeters (mm) and about 0.6 mm. In some examples, the sensor cover comprises a hexagon shape or square shape. In some examples, the sensor cover comprises a diameter between about 15 mm and about 25 mm. In some examples, the sensor cover comprises a silicon material. The sensor cover may be transparent to infrared light. The sensor cover may comprise a light wavelength transmission spectrum range between about 5 μm and about 20 μm. In some examples, the sensor cover is attached to the substrate with an adhesive. The sensor cover may be polished on an outer surface and on an inner surface.

Another aspect of the disclosure relates to a sensor cover device, comprising a silicon plate disposed between a sensor and a sample chamber of a water activity meter, wherein the sensor is disposed in a cavity of a substrate of the water activity meter, and wherein the silicon plate is configured to prevent contamination of the sensor and to permit infrared electromagnetic radiation to pass through the silicon plate into the cavity.

In some examples, the silicon plate comprises a first surface and a second surface, wherein the first surface is attached to the substrate, and wherein the first surface and the second surface are polished.

In some examples, the silicon plate comprises a hexagonal shape. In some examples, the water activity meter further comprises a resistive electrolytic sensor. In some examples, the silicon plate comprises an elemental silicon transparent to infrared light. In some examples, the water activity meter further comprises a capacitive hygrometer. In some examples, the water activity meter further comprises a chilled-mirror dew point sensor. In some examples, the water activity meter further comprises a tunable diode laser. In some examples, the sample chamber further comprises a balance configured to weigh the sample.

Yet another aspect of the disclosure relates to a method of protecting a sensor from contamination, the method comprising: assembling a water activity meter comprising a sample chamber having a lid and a sensor disposed in a cavity of the lid, wherein the lid selectively closes and opens the sample chamber; and providing a sensor cover over the cavity of the lid, the sensor cover comprising a silicon plate comprising a first surface attached to a surface of the lid surrounding the cavity, wherein the silicon plate is transmissive of electromagnetic radiation having a wavelength ranging between about 5 μm and about 20 μm.

The method may further comprise transmitting the electromagnetic radiation through the silicon plate to the sensor. In some examples, the sensor cover is polished on the first surface and on a second surface. In some examples, the method further comprises sealing the cavity with the sensor cover.

### BRIEF DESCRIPTION OF THE DRAWINGS

The accompanying drawings and figures illustrate exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is an isometric view of a water activity meter with a sensor station.

FIG. 2 is a schematic side view of a thermopile temperature sensor station.

FIG. 3A is an isometric view of the lid of the sensor station of FIG. 1 with a cover added.

FIG. 3B is a schematic partial cross-sectional view of the lid of the sensor station of FIG. 3A.

FIG. 4 is a graphical representation of the transmission properties of a sensor and sensor cover.

FIG. 5 is a block flow diagram for a method to protect a sensor from contamination.

While the embodiments described herein are susceptible to various modifications and alternative forms, specific embodiments have been shown by way of example in the drawings and will be described in detail herein. However, the exemplary embodiments described herein are not intended to be limited to the forms disclosed. Rather, the instant disclosure covers all modifications, equivalents, and alternatives falling within the scope of the appended claims.

### DETAILED DESCRIPTION

Embodiments disclosed herein are related to assemblies, systems, and methods of determining properties of a sample material (e.g., a food product) with a sensor system. The assemblies, systems, and methods may include protecting a sensor for determining a temperature of a sample when placed in a water activity meter or other device or test instrument using a sensor-based system. In some examples, the sensor can be attached to a water activity meter system to, at least in part, provide a measurement of the energy status of the water in the system. By measuring the water activity of a sample product, the sensor can be used to estimate the physical stability and shelf life of the sample product. Water activity is the relative humidity of air in equilibrium with a sample in a sealed chamber. The concept of water activity is of particular importance in determining product quality and safety. Since water activity describes the thermodynamic energy status of the water within a system, there is a close relationship between water activity and the physical stability and shelf life of products. Differences in water activity levels between components or a component and the environmental humidity is a driving force for moisture migration.

There are several factors that control water activity in a system. Colligative effects of dissolved species (e.g., salt or sugar) interact with water through dipole-dipole, ionic, and hydrogen bonds. Capillary effect where the vapor pressure of water above a curved liquid meniscus is less than that of pure water because of changes in the hydrogen bonding between water molecules. Surface interactions in which water interacts directly with chemical groups on undissolved ingredients (e.g. starches and proteins) through dipole-dipole forces, ionic bonds (H3O+ or OH−), van der Waals forces (hydrophobic bonds), and hydrogen bonds.

Water activity is temperature dependent. Temperature changes water activity due to changes in water binding, dissociation of water, solubility of solutes in water, or the state of the matrix. Although solubility of solutes can be a controlling factor, control is usually from the state of the matrix. For example, for food, since the state of the matrix (e.g., a glassy or a rubbery state) is dependent on temperature, one should not be surprised that temperature affects the water activity. The effect of temperature on the water activity of a food is product specific. Some products increase water activity with increasing temperature, others decrease with increasing temperature, while most high moisture foods have negligible change with temperature.

In some example embodiments of the present disclosure, the sensor can include a sensor system that can be used to detect a physical parameter of interest (e.g., heat, light, sound) by converting it into an electrical signal that can be measured and used by an electrical or electronic system. The detected parameter is usually a property of the material or the testing environment that is measured as an analog signal and is converted into electrical energy or a digital signal using the sensor/a transducer. Because the sensor is generally placed in the vicinity of a sample which is emitting heat or light or is liquefying, boiling, or dissolving to some extent, the sensor can be subjected to a harsh environment that may have a negative effect on the accuracy or durability of the sensor.

For example, a thermopile sensor is based on thermocouples. Thermopiles sense the electromagnetic radiation which is emitted from the surface of any object or body with a temperature above absolute zero. This radiation has a broadband spectral distribution that depends on the surface temperature of the object or body. In equipment such as water activity meters, thermopiles may be placed in a sealed container (e.g., a metal can), chamber, or cavity along with the sample material for which the water activity is being detected. Due to high testing temperatures and potentially corrosive byproducts of heating the sample and controlling the humidity of the sealed container, the container, the thermopile, and anything else in the container is susceptible to corrosion. The delicate structures of the thermopile can be damaged in these situations, leading to inaccuracy of measurements. Notably, thermopiles can include and use a silicon cover within the thermopile sensor to protect the internal circuitry. However, the materials susceptible to corrosion are not just the internal sensing circuitry of the thermopile. The container and the exterior surfaces of the metal can that houses the thermopile sensor circuitry are vulnerable to and prone to corrosion and damage. A system for protecting a thermopile temperature sensor and the container that houses the thermopile temperature sensor is warranted to improve the longevity of the sensor system and to maintain the accuracy of the sensor. As such, the sensor cover disclosed herein is configured to cover and protect the sensor station and/or the thermopile temperature sensor in its entirety and not solely the internal components and circuitry of the sensor. In some examples, a thermopile sensor of the present disclosure can include a flat infrared filter and a thermistor for temperature compensation in a single package. The thermopile can measure surface temperature without contact via infrared measurements. In some cases, sensor covers disclosed herein can be incorporated into other instrumentation such as a tunable diode laser (TDL), a water activity meter, or a vapor sorption analyzer.

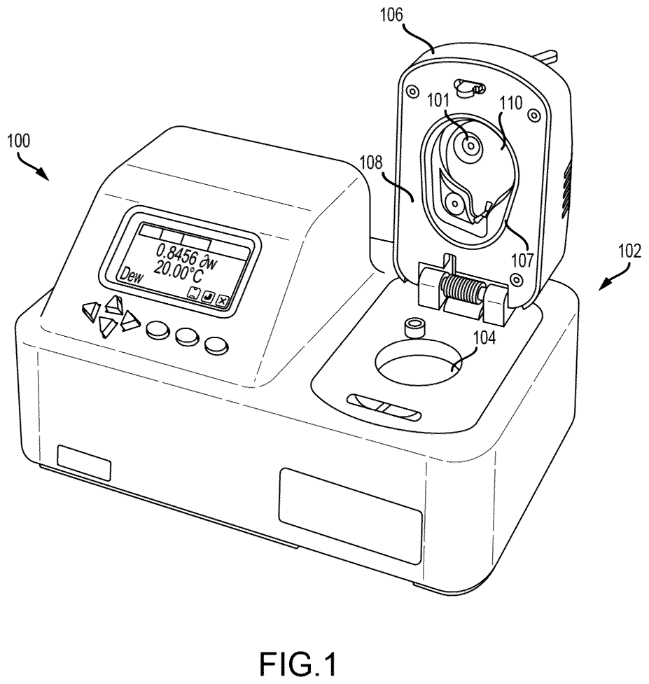

FIG. 1 is an isometric view of a water activity meter 100 including a sensor station 102. The sensor station 102 can include a thermopile temperature sensor 101. A sample can be placed in a lower chamber 104 (e.g., a lower cavity or bottom test chamber portion) of the sensor station 102. The sensor station 102 can also include a lid or door 106 (e.g., a chamber top cover) shown in FIG. 1 in an open position. While in the open position, the door 106 can expose a lower chamber 104. The door 106 can move to a closed position while taking measurements. The door 106 may include a substrate 108 (e.g., a bottom panel or inner housing of the door 106 defining an upper side of the sample chamber 104) that includes an upper chamber 110 (e.g., an upper cavity or upper test chamber portion). When the door 106 closes, the upper chamber 110 and the lower chamber 104 can collectively define a sample chamber or testing chamber of the sensor station 102.

The thermopile temperature sensor 101 can be disposed in the cavity 110, such as by being positioned in a ceiling or top surface of the upper chamber 110 that is configured to face inward toward the sample chamber (e.g., the combined upper and lower chambers 104, 110) and downward when the door 106 of the sensor station 102 is moved to the closed position. The sensor station 102 may include a gasket 107 or similar structure surrounding the perimeter of the upper chamber 110 and configured to seal and prevent leakage of material or gases from the sample chamber 104 and upper chamber 110 while testing is underway.

The sensor station 102 can also include various electronics, temperature control units (e.g., heaters), circulation devices (e.g., fans), and other components of water activity meters known by those having ordinary skill in the art and the benefit of the present disclosure. In some examples, the sensor station 102 or water activity meter can include other types of sensors and/or measurement devices, such as a vapor sorption analyzer (VSA). In some cases, the sensor station 102 can include a balance underneath the sample to measure weight. In such cases, the sample chamber (e.g., the combined upper and lower chambers 104, 110) may not be completely sealed. Rather, the sensor station 102 can be configured to control the humidity within the chamber and monitor weight changes of the sample when the sample is exposed to different humidities and temperatures.

In some examples, the sensor station 102 can also include an electrolytic sensor (e.g., a resistive electrolytic sensor), a capacitive hygrometer, a dew point sensor, another similar sensor, or combinations thereof. In some cases, these sensors can be used to measure water activity by measuring the resistance of a liquid electrolyte that changes when it absorbs or loses water vapor. The resistance is proportional to the relative air humidity and water activity of the sample. In some cases, humidity or water content can be sensed by capacitance using moisture-sensitive dielectrics. The sensor function may depend on the fact that a water molecule is highly polarized (with a dielectric constant of around 80), which can be much higher than polymers. When the dielectric absorbs water vapor, its dielectric constant increases, thus increasing the capacitance. At lower humidity, the dielectric gives up some water, and the capacitance goes back down. The change is nearly linear with relative humidity and may be slightly affected by temperature.

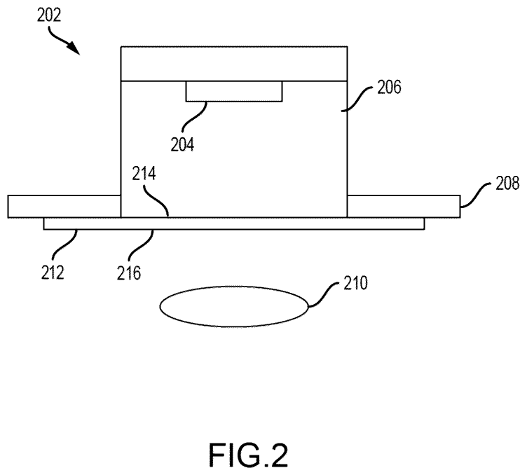

FIG. 2 is a schematic side view of a thermopile temperature sensor station 202. The sensor station 202 can be the same as that shown in FIG. 1 or can have a different design. The sensor station 202 can include a sensor 204. In some examples, the sensor 204 can include at least one of a temperature sensor (e.g., a thermopile), however other sensors that may need protection using a silicon cover over the sensor's sensing element may be included.

The sensor 204 can be disposed in a cavity 206 such as, for example, the upper chamber 110 or a portion of the upper chamber 110. The cavity 206 can be defined in a substrate 208 or other upper housing area of the sensor station 202 (e.g., in the ceiling or top surface of the substrate 208 or upper chamber 110). For example, the substrate 208 can be the same as substrate 108 shown in FIG. 1. The sensor 204 can be configured to sense a property of a sample 210 outside the cavity 206, e.g., in a lower test chamber 104. In some examples, the sample 210 can include a food, a chemical, a solid or a liquid, a biological material, or any other suitable material. The sensor 204 can be configured in the cavity such that the sensor 204 has a field of view that is wide enough to observe the full area of the sample 210.

A sensor cover 212 can be disposed between the sensor 204 and the sample 210. In some examples, the sensor cover 212 can include a silicon-based material. For example, the sensor cover 212 can include a silicon plate. In some examples, the sensor cover 212 can be configured to shield the sensor 204. The sensor cover 212 can be attached to the substrate 208. In some examples, the sensor cover 212 can be attached around its perimeter with an adhesive, sealant, fasteners, gasket, and/or other suitable attachment material or mechanism. For example, the sensor cover 212 can be glued to the substrate 208 or otherwise continuously sealed around its perimeter edges on its first surface 214 or second surface 216. The sensor cover 212, using at least one attachment mechanism, can seal the cavity 206 at or around the substrate 208 so that no materials (e.g., liquids and/or gases) can penetrate or permeate from the sample 210 or the sample testing chamber into the cavity 206. The sensor cover 212 can thereby prevent contamination and/or corrosion of the sensor 204 due to prevention of contaminants or corrosive materials from passing into contact with the sensor 204 in the cavity 206.

In some examples, the sensor cover 212 can have an overall thickness between about 0.3 millimeters (mm) and about 0.6 mm. In some examples, the sensor cover 212 can have a thickness ranging between about 0.3 mm to about 0.4 mm, between about 0.4 mm to about 0.45 mm, between about 0.45 mm to about 0.5 mm, between about 0.5 mm to about 0.55 mm, or between about 0.55 mm to about 0.6 mm. The thickness of the sensor cover 212 can affect is durability and its ability to permit or block light or other radiation through it.

In some examples, the sensor cover 212 can include a first surface 214 (e.g., a top surface or sensor-facing surface) and a second surface 216 (e.g., a bottom surface or sample-facing surface). In an example, the first surface 214 can be attached to the substrate 208. One or both of the first surface 214 and the second surface 216 can be polished. In one embodiment, both sides of the sensor cover 212 are treated to substantially remove any defects or imperfections in the surface so that light can pass cleanly and with minimal reflection or refraction through the surfaces 214, 216. The sensor cover 212 can include an elemental silicon. In other words, the sensor cover 212 can comprise a pure silicon material without any doping or inclusions.

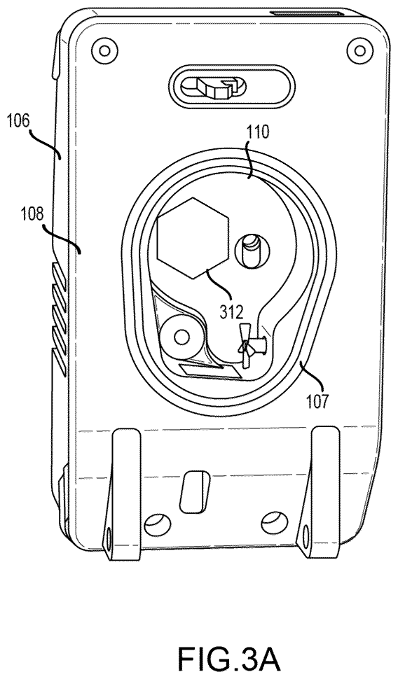

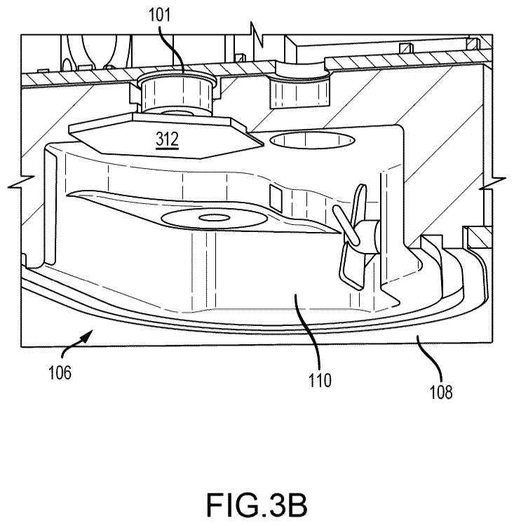

FIG. 3A is an isometric view of the lid of the sensor station 102 of FIG. 1 with a sensor cover 312 installed over the sensor 101. The sensor cover 312 can have the properties and features of sensor cover 212 (and vice versa). As shown in FIG. 3A, the sensor cover 312 may overlay and act as a window between the sensor 101 disposed behind the sensor cover 312 and the upper chamber 110. The sensor cover 312 can be attached to and can move with the door 106 and can therefore also stay in a static position relative to the sensor 101 within.

In various examples, the sensor cover 312 can have a hexagonal outer perimeter shape (as shown in FIG. 3A), a circular shape, a triangular shape, or a square shape. The shape of the sensor cover 312 can be dependent on manufacturing limitations or space limitations in the sensor station 102. The outer shape of the sensor cover 312 can correspond to a recess or receiving slot in the upper chamber 110 configured to hold or be sealed to the sensor cover 312, as shown in FIG. 3B. The sensor cover 312 can be configured to be flush with the ceiling or other upper surface of the upper chamber 110, thereby limiting or preventing airflow interference caused by the sensor cover 312 in the sample testing chamber.

In some examples, the sensor cover 312 can exhibit a diameter or major or lateral width dimension between about 15 mm and about 25 mm. In some examples, the sensor cover 312 can have a diameter ranging between about 15 mm to about 18 mm, about 18 mm to about 20 mm, about 20 mm to about 22 mm, about 22 mm to about 24 mm, or about 24 mm to about 25 mm. The sensor cover 312 can be sized and shaped sufficient to completely cover the sensor 101/204. The thickness of the sensor cover 312 can be about 0.43 mm or within a range between about 0.35 mm and about 0.50 mm.

As shown in FIG. 3A, the sensor cover 312 can cover the sensor 101 without completely enclosing or covering the rest of the upper chamber 110. As shown in FIG. 2, the sensor cover 312 can cover and enclose the cavity 206 with space between the sensor 204 and the sensor cover 312. The sensor 101, 204 may have non-planar surfaces that are spaced away from planar surfaces (e.g., 214, 216) of the cover 312 by a gap, and in some examples, the sensor cover 212 can contact the sensor 101, 204. See FIG. 3B.

FIG. 3B is a schematic partial cross-sectional view of the sensor station 102 shown in FIG. 3A. The sensor cover 312 is shown preventing contamination of the sensor 101 due to the silicon plate sealing the cavity where the sensor 101 is located. In some examples, the sensor cover 312 is transparent to a set of wavelengths of light, such as infrared light. Infrared light includes electromagnetic radiation with wavelengths longer than that of visible light but shorter than microwaves. Infrared light can generally understood to include wavelengths from around 750 nm (400 THz) to 1 mm (300 GHz).

The sensor cover 312 is configured to permit electromagnetic radiation through the sensor cover 312 to the thermopile temperature sensor 101. In some examples, the sensor cover 312 can exhibit a light wavelength transmission spectrum range between about 5 microns (μm) and about 20 μm. The sensor cover 312 can permit an infrared electromagnetic radiation to pass through the plate and can therefore be referred to as an infrared window or transparent panel. In some examples, the sensor cover 312 can exhibit a wavelength transmission spectrum range between about 5 μm and about 8 μm, between about 8 μm and about 10 μm or in ranges of about 10 μm to about 12 μm, about 12 μm to about 15 μm, about 15 μm to about 18 μm mm, or about 18 μm to about 20 μm.

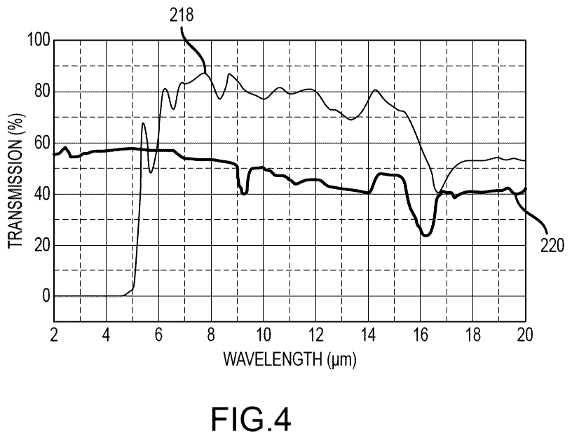

FIG. 4 is a graphical representation plotting light transmission properties of an embodiment of the sensor cover (e.g., 212 or 312) comprising a silicon material. The line labeled 218 is the transmission spectrum of an example thermopile sensor, and the line labeled 220 is a silicon infrared filter transmission spectrum. As can be seen in FIG. 4, their shared bandwidth (wavelength) is between about 5 μm and about 20 μm. Accordingly, in an example, a sensor cover comprising raw silicon will effectively transmit infrared light in the wavelengths measured by a thermopile sensor.

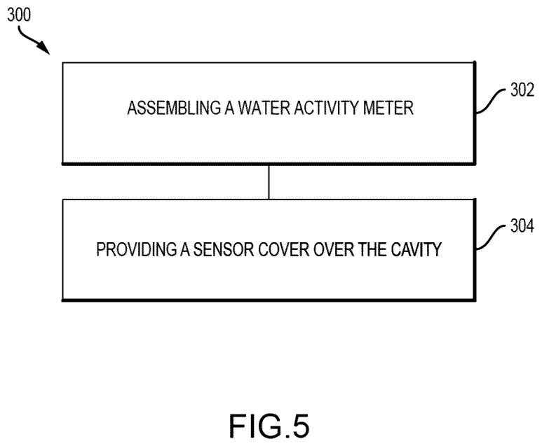

FIG. 5 is a block flow diagram for a method 300 to protect a sensor from contamination. The method 300 for protecting a sensor from contamination may utilize use any of the sensor systems and/or assemblies disclosed herein. The method 300 may include block 302, which includes assembling a water activity meter. The water activity meter can include a sensor station (e.g., sensor station 102 or 202) with a sensor (e.g., 101, 204) disposed therein, such as a thermopile temperature sensor located in the vicinity of a sample chamber (e.g., 104, 110). In some examples, the sample chamber can have a lid (e.g., door 106) and a sensor disposed in a cavity (e.g., 110, 206) of the lid, wherein the lid selectively covers, seals, closes, uncovers, unseals, or opens the sample chamber. The sample chamber can hold a sample material (e.g., 210). The sensor can be located in a cavity (e.g., 206) of a substrate (e.g., 108, 208) of the sensor station. The method 300 may further include block 304, which includes providing a sensor cover over the cavity of the lid. In some examples, the sensor cover can be configured to seal the cavity. In other words, the cavity can be sealed airtight by the sensor cover, but the sensor cover can allow light of one or more designated wavelengths to pass through the sensor cover to the sensor. Performing blocks 302 and 304 can enable a sensor system to prevent contamination of a sensor (e.g., thermopile) from substances in the sample chamber (e.g., the sample material itself, water, smoke, chemicals, etc.) while still allowing measurements of properties of the sample material or the sample chamber (e.g., temperature) through the sensor cover.

In some examples, the sensor cover can include a silicon plate having a first surface and a second surface, with the first surface being attached to a surface of the lid surrounding the cavity and the second surface facing the sample. During operation of the sensor station, electromagnetic radiation having a transmission spectrum range between about 5 μm and about 20 μm passes through the plate. In some examples, the sensor cover is polished on both the first surface and the second surface to facilitate transmittivity.

Blocks 302 and 304 of the method 300 are shown for illustrative purposes. For example, all acts or blocks illustrated of the method 400 may be performed in different orders, split into multiple acts, modified, supplemented, or combined. In an example, one or more of the acts of the method 300 may be omitted from the method 300. Any of the acts of the method 300 can include using any of the sensor assemblies or systems disclosed herein.

While various aspects and embodiments have been disclosed herein, other aspects and embodiments are contemplated. The various aspects and embodiments disclosed herein are for purposes of illustration and are not intended to be limiting. The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, or +2% of the term indicating quantity. Further, the terms “less than,” “or less,” “greater than,” “more than,” or “or more” include, as an endpoint, the value that is modified by the terms “less than,” “or less,” “greater than,” “more than,” or “or more.” In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

As used herein, conjunctive terms (e.g., “and”) and disjunctive terms (e.g., “or”) should be read as being interchangeable (e.g., “and/or”) whenever possible. Furthermore, in claims reciting a selection from a list of elements following the phrase “at least one of,” usage of “and” (e.g., “at least one of A and B”) requires at least one of each of the listed elements (i.e., at least one of A and at least one of B), and usage of “or” (e.g., “at least one of A or B”) requires at least one of any individual listed element (i.e., at least one of A or at least one of B). It is noted that, when described or recited herein, the use of the articles such as “a” or “an” is not considered to be limiting to only one, but instead is intended to mean one or more unless otherwise specifically noted herein.

What is claimed is:

1. A system for protecting a thermopile temperature sensor, the system comprising:
a water activity meter comprising a thermopile temperature sensor and a substrate and defining a sample chamber;
wherein the substrate of the water activity meter defines a cavity containing the thermopile temperature sensor; and
a sensor cover attached to the substrate and sealing the cavity, wherein the sensor cover is configured to permit electromagnetic radiation to pass through the sensor cover to the thermopile temperature sensor from the sample chamber.

2. The system of claim 1, wherein the sensor cover comprises a thickness between about 0.3 mm and about 0.6 mm.

3. The system of claim 1, wherein the sensor cover comprises a hexagon shape or square shape.

4. The system of claim 1, wherein the sensor cover comprises a diameter between about 15 mm and about 25 mm.

5. The system of claim 1, wherein the sensor cover comprises a silicon material.

6. The system of claim 1, wherein the sensor cover is transparent to infrared light.

7. The system of claim 1, wherein the sensor cover comprises a light wavelength transmission spectrum range between about 5 μm and about 20 μm.

8. The system of claim 1, wherein the sensor cover is attached to the substrate with an adhesive.

9. The system of claim 1, wherein the sensor cover is polished on an outer surface and on an inner surface.

10. A sensor cover device, comprising:
a silicon plate disposed between a sensor and a sample chamber of a water activity meter, wherein the sensor is disposed in a cavity of a substrate of the water activity meter;
wherein the silicon plate is configured to prevent contamination of the sensor and to permit infrared electromagnetic radiation to pass through the silicon plate into the cavity.

11. The sensor cover device of claim 10, wherein the silicon plate comprises a first surface and a second surface, wherein the first surface is attached to the substrate, and wherein the first surface and the second surface are polished.

12. The sensor cover device of claim 10, wherein the silicon plate comprises a hexagonal shape.

13. The sensor cover device of claim 10, wherein the water activity meter further comprises a resistive electrolytic sensor.

14. The sensor cover device of claim 10, wherein the silicon plate comprises an elemental silicon transparent to infrared light.

15. The sensor cover device of claim 10, wherein the water activity meter further comprises a capacitive hygrometer.

16. The sensor cover device of claim 10, wherein the sample chamber further comprises a balance configured to weigh the sample.

17. A method of protecting a sensor from contamination, the method comprising:
assembling a water activity meter comprising a sample chamber having a lid and a sensor disposed in a cavity of the lid, wherein the lid selectively closes and opens the sample chamber;
providing a sensor cover over the cavity of the lid, the sensor cover comprising a silicon plate comprising a first surface attached to a surface of the lid surrounding the cavity, wherein the silicon plate is transmissive of electromagnetic radiation having a wavelength ranging between about 5 μm and about 20 μm.

18. The method of claim 17, further comprising transmitting the electromagnetic radiation through the silicon plate to the sensor.

19. The method of claim 17, wherein the sensor cover is polished on the first surface and on a second surface.

20. The method of claim 17, further comprising sealing the cavity with the sensor cover.
